(19) United States
(12) Patent Application Publication
(10) Pub. No.: US 2022/0361649 A1
(43) Pub. Date: Nov. 17, 2022

(54) DRINK CONTAINER WITH SPRAYER AND RELATED METHODS

(71) Applicant: RiViv, LLC, Denver, CO (US)

(72) Inventor: Skye Forrest, Denver, CO (US)

(21) Appl. No.: 17/319,469

(22) Filed: May 13, 2021

(51) Int. Cl. A45F 3/18; B65D 1/02; A45D 34/04; A23L 2/52; A23L 33/16; B05B 11/00

(52) U.S. Cl. CPC A45F 3/18; B65D 1/0223; A45D 34/04; A23L 2/52; A23L 33/16; B05B 11/30; B65D 2501/0036; A45F 2003/003

(57) ABSTRACT

A drink container and related methods are disclosed hereon. A method of making a drink container includes (a) providing a beverage bottle for holding a beverage for human consumption; (b) forming a threaded mouth in the beverage bottle, the threaded mouth meeting government safety standards for drink containers; (c) providing a removable cap; (d) forming a threaded recess in the removable cap, the threaded recess meeting government safety standards for caps for drink containers, the removable cap further having a sprayer and a dip tube; and (f) threading the removable cap onto the beverage bottle and causing the dip tube to extend into the beverage bottle.

### FIELD

This invention is related to consumer beverages. Specifically, but not intended to limit the invention, embodiments of the invention are related to water bottles.

### BACKGROUND

During hot seasons or activities, it is common for consumers to carry water bottles to ensure they have enough water to consume during the day. It is also common for people, and women in particular, to apply lotions to their skin as part of a skin care routine, often during morning or evening routines. There remains a need, however, for easy access to drinking beverages and skin hydration means throughout the day, particularly in dry climates, and/or other new and useful innovations.

### SUMMARY

An exemplary method of making a drink container includes providing a beverage bottle for holding a beverage for human consumption and forming a threaded mouth in the beverage bottle, the threaded mouth meeting government safety standards for drink containers. The exemplary method includes providing a removable cap and forming a threaded recess in the removable cap, the threaded recess meeting government safety standards for caps for drink containers, the removable cap further having a sprayer and a dip tube. The exemplary method includes threading the removable cap onto the beverage bottle and causing the dip tube to extend into the beverage bottle.

An exemplary method includes providing a drink container, the drink container having (a) a beverage bottle for holding a beverage for human consumption and hydration of human skin, the beverage bottle further having a threaded mouth and (b) a removable cap coupled to the beverage bottle, the removable cap threaded onto the beverage bottle with a threaded recess to prevent leakage of the beverage, the removable cap further having a sprayer and a dip tube, the dip tube extending into the beverage bottle. The exemplary method includes drinking the beverage from the drink container and manipulating the sprayer to mist the beverage onto human skin.

An exemplary drink container includes a beverage bottle and a removable cap. The beverage bottle is for holding a beverage for human consumption and hydration of human skin, the beverage bottle further having a threaded mouth. The removable cap is coupled to the beverage bottle, the removable cap threaded onto the beverage bottle with a threaded recess to prevent leakage of the beverage for human consumption and hydration of human skin, the removable cap further having a sprayer and a dip tube, the dip tube extending into the beverage bottle.

### BRIEF DESCRIPTION ON THE DRAWINGS

FIG. 1 is a perspective view of a drink container according to embodiments herein;

FIG. 2 is a side view of the drink container;

FIG. 3 is a side view of the top portion of the drink container with the removable cap removed;

FIG. 4 is a bottom perspective view of the removable cap;

FIG. 5 is a flow chart of a method; and

FIG. 6 is a flow chart of a method.

### DETAILED DESCRIPTION

As previously described herein, it is common for people to carry water bottles on their persons to ensure they have enough drinking water during the day. It is also common for people to apply moisturizing lotions to their skin as part of a skin care regimen during their morning or evening routines. There remains a need, however, for easy hydration of people's skin throughout the day, especially in dry climates. There also remains a need for reducing the burden of carrying numerous body care products, such as a water bottle and a skin hydration product, during the day.

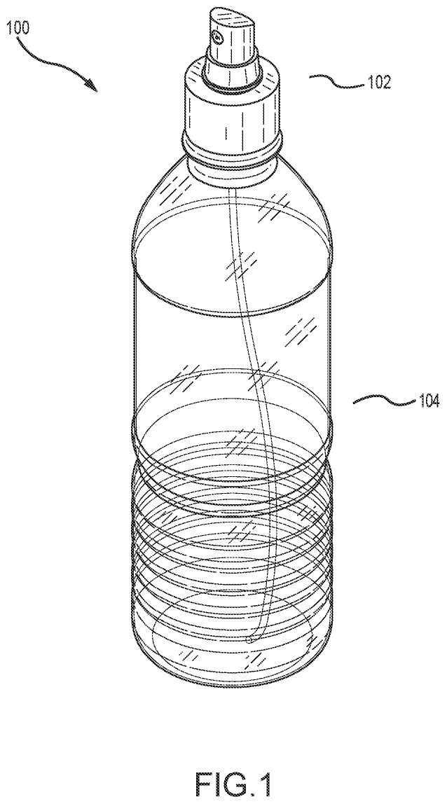

The Applicant has overcome the problems described herein by providing a drink container 100 such as the drink container illustrated in FIG. 1.

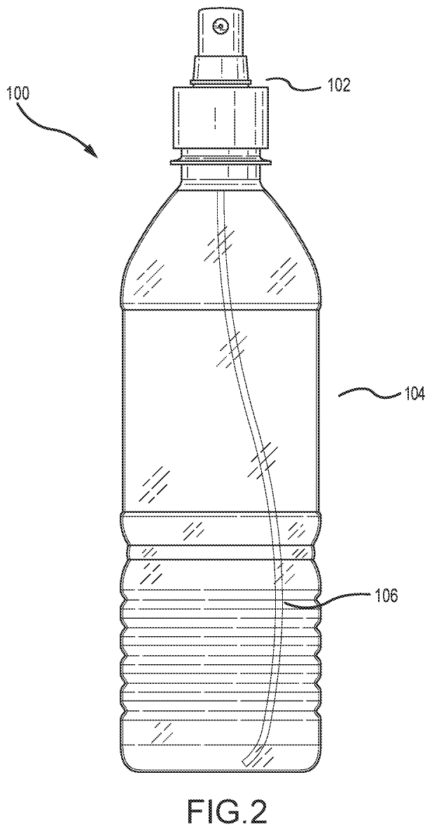

The drink container 100 illustrated in FIGS. 1-4 includes a beverage bottle 104 and a removable cap 102.

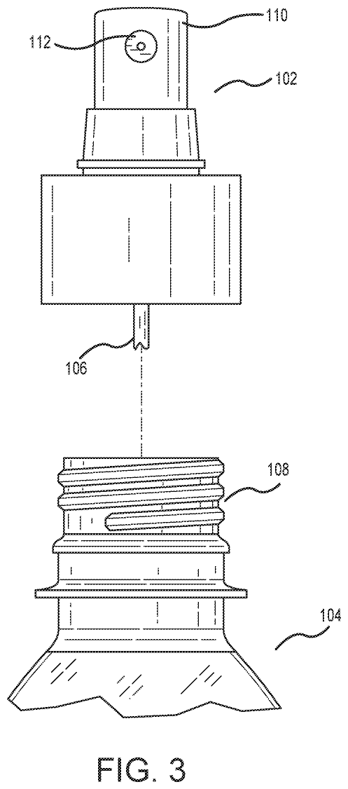

The beverage bottle 104 is configured for holding a beverage for human consumption and hydration of human skin. The beverage bottle 104 has a threaded mouth 108 (see e.g. FIG. 3).

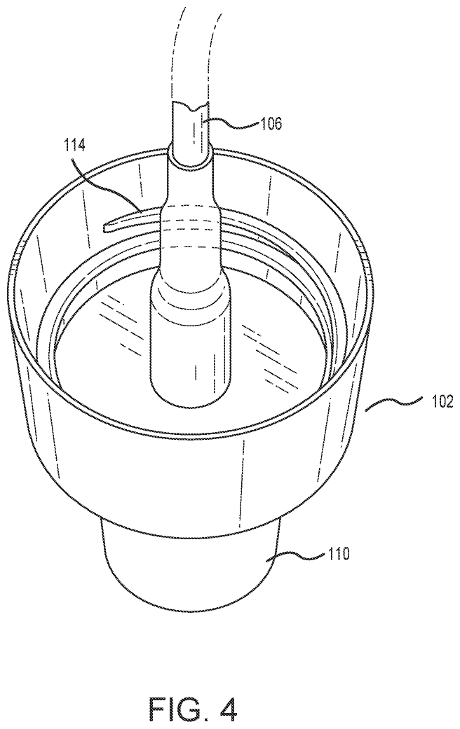

The removable cap 102 may be coupled to the beverage bottle 104. The removable cap 102 may be threaded onto the beverage bottle 104 with a threaded recess 114 (see e.g. FIG. 4) to prevent leakage of the beverage for human consumption and hydration of human skin.

The removable cap 102 has a sprayer 110 (see e.g. FIG. 3) such as a pump action misting device known to those skilled in the art for misting a liquid, such as water, through an exit port 112.

A dip tube 106 may be coupled to the removable cap 102 and configured to extend into the beverage bottle 104.

The threaded mouth 108 and the threaded recess 114 are configured to meet Food and Drug Administration (FDA) and/or other government safety standards for products for storing human foods or beverages. Notably, sprayers that are currently available on the market do not meet FDA or other government safety standards and are not configured to be attached to beverage containers. Indeed, the standards for threading on currently-available sprayers render them unattachable to beverage containers.

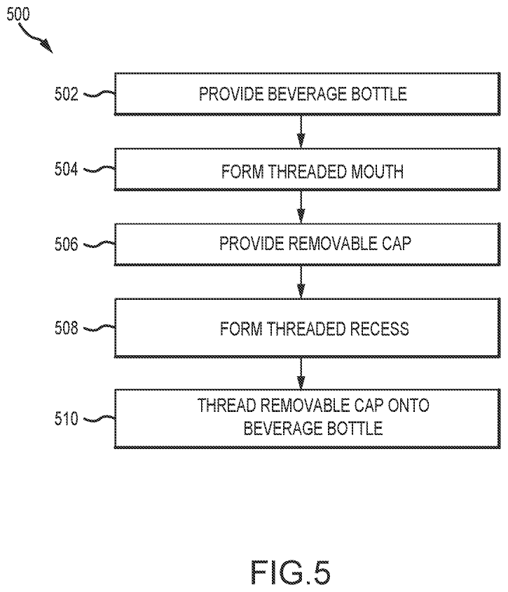

Turning now to FIG. 5, a method 500 of making a drink container is described. The method 500 includes providing a beverage bottle 502 for holding a beverage for human consumption, and forming a threaded mouth 504 in the beverage bottle, the threaded mouth meeting government safety standards for drink containers. The method 500 further includes providing a removable cap 506, and forming a threaded recess 508 in the removable cap, the threaded recess meeting government safety standards for caps for drink containers, the removable cap further having a sprayer and a dip tube. The method 500 further includes threading the removable cap onto the beverage bottle 510 and causing the dip tube to extend into the beverage bottle.

The method 500 may include, prior to threading the removable cap onto the beverage bottle, filling the beverage bottle with a beverage fit for human consumption. The beverage fit for human consumption may be further fit for hydrating human skin.

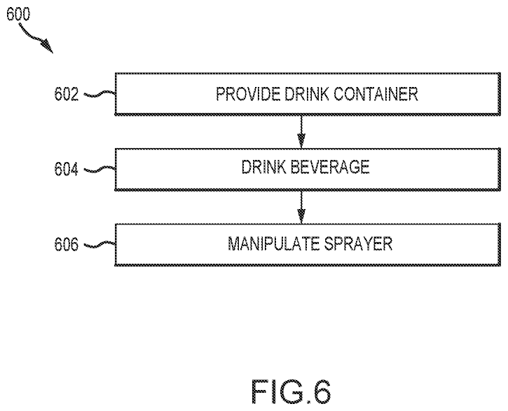

Turning now to FIG. 6, a method 600 is described. The method 600 includes providing a drink container 602 according to embodiments of the drink container 100 described herein. The method 600 includes drinking 604 the beverage from the drink container, and manipulating 606 the sprayer to mist the beverage onto human skin.

The method 600 may include twisting the removable cap off the beverage bottle.

Misting the beverage onto the user's skin may include hydrating the user's skin.

The beverage may be a water suitable for human consumption.

The beverage may consist of a beverage and minerals suitable for human consumption.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “fastener” should be understood to encompass disclosure of the act of “fastening”—whether explicitly discussed or not—and, conversely, were there only disclosure of the act of “fastening”, such a disclosure should be understood to encompass disclosure of a “fastening mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only.

Similarly, the claim shall also read on a device that requires “A+B”. The claim shall also read on a device that requires “A+B+C”, and so forth.

The claims shall also be construed such that any relational language (e.g. perpendicular, straight, parallel, flat, etc.) is understood to include the recitation “within a reasonable manufacturing tolerance at the time the device is manufactured or at the time of the invention, whichever manufacturing tolerance is greater”.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

1. A method of making a drink container, the method comprising:
providing a beverage bottle for holding a beverage for human consumption;
forming a threaded mouth in the beverage bottle, the threaded mouth meeting government safety standards for drink containers;
providing a removable cap;
forming a threaded recess in the removable cap, the threaded recess meeting government safety standards for caps for drink containers, the removable cap further having a sprayer and a dip tube;
threading the removable cap onto the beverage bottle and causing the dip tube to extend into the beverage bottle.

2. The method of claim 1, further comprising:
prior to the threading the removable cap onto the beverage bottle, filling the beverage bottle with a beverage fit for human consumption.

3. The method of claim 2, wherein:
the beverage fit for human consumption is further fit for hydrating human skin.

4. A method, comprising:
providing a drink container, the drink container having (a) a beverage bottle for holding a beverage for human consumption and hydration of human skin, the beverage bottle further having a threaded mouth and (b) a removable cap coupled to the beverage bottle, the removable cap threaded onto the beverage bottle with a threaded recess to prevent leakage of the beverage, the removable cap further having a sprayer and a dip tube, the dip tube extending into the beverage bottle;
drinking the beverage from the drink container; and
manipulating the sprayer to mist the beverage onto human skin.

5. The method of claim 4, comprising:
twisting the removable cap off the beverage bottle.

6. The method of claim 4, wherein:
the misting the beverage onto the user's skin comprises hydrating the user's skin.

7. The method of claim 4, wherein:
the beverage comprises a water suitable for human consumption.

8. The method of claim 4, wherein:
the beverage consists of a beverage and minerals suitable for human consumption.

9. The method of claim 4, wherein:
the drink container, the removable cap, and the dip tube are Food and Drug Administration compliant.

10. A drink container comprising:
a beverage bottle for holding a beverage for human consumption and hydration of human skin, the beverage bottle further having a threaded mouth; and
a removable cap coupled to the beverage bottle, the removable cap threaded onto the beverage bottle with a threaded recess to prevent leakage of the beverage for human consumption and hydration of human skin, the removable cap further having a sprayer and a dip tube, the dip tube extending into the beverage bottle.
